(19) United States
(12) Patent Application Publication
(10) Pub. No.: US 2025/0084549 A1
(43) Pub. Date: Mar. 13, 2025

(54) MEMBRANE ELECTRODE ASSEMBLY

(71) Applicant: EvolOH, Inc., Palo Alto, CA (US)

(72) Inventors: Ashutosh DIVEKAR, Palo Alto, CA (US); Philipp Karl MUSCHER, Palo Alto, CA (US); Jimmy Andrey ROJAS HERRERA, Palo Alto, CA (US)

(21) Appl. No.: 18/811,309

(22) Filed: Aug. 21, 2024

Related U.S. Application Data
(60) Provisional application No. 63/520,820, filed on Aug. 21, 2023.

(51) Int. Cl. C25B 13/08; B01J 41/12; C25B 9/23

(52) U.S. Cl. CPC C25B 13/08; B01J 41/12; C25B 9/23

(57) ABSTRACT

The present application relates to membrane electrodes, particularly electrolyzer devices, including innovative materials and approaches to membrane electrode design and fabrication.

### INCORPORATION BY REFERENCE OF RELATED APPLICATIONS

This application is based upon and claims the benefit of priority under 35 U.S.C. § 119 (e) to U.S. Provisional Application No. 63/520,820, filed Aug. 21, 2023, the entire contents of all of which are incorporated herein by reference in their entirety.

### FIELD OF THE INVENTION

The present application relates to membrane electrodes, particularly electrolyzer devices, including innovative materials and approaches to membrane electrode design and fabrication.

### BACKGROUND

Water electrolysis, also known as “water splitting,” forms oxygen gas (O₂) and hydrogen gas (H₂) by decomposing liquid water (H₂O). The gas evolution happens when an electric current is flown through a device at a voltage of at least 1.23V applied across an anode and a cathode. Hydrogen and oxygen gases evolved at the cathode and anode respectively. Hydrogen gas has been described as a fuel for a cleaner future which could be used in transportation as well as industrial applications, such as Haber-Bosch process to generate ammonia. Oxygen gas finds applications as an oxidizing reagent, or a component of breathable air used by astronauts and cosmonauts residing at the International Space Station (ISS) for maintaining their life-supporting oxygen supply.

The two primary water electrolysis approaches currently commercialized include alkaline electrolysis and proton exchange membrane (PEM) electrolysis. Alkaline electrolyzers are less efficient than PEM electrolyzers and rely on liquid electrolytes which are often corrosive. The initial capital expenditure and balance of plant (supporting components and auxiliary systems) of these systems are expensive, requiring a larger plant to produce the same material output. PEM electrolyzers achieve higher current densities than alkaline electrolyzers, but they have their own drawbacks. Although they can be operated using pure water with no added electrolytes, they operate in acidic environments, which requires expensive anode and cathode catalyst materials (e.g., platinum-group metal electrodes) and expensive bipolar plates, such as titanium. Therefore, the initial capital expenditure is significantly increased.

Anion exchange membrane electrolyzers (AEMELs), which can operate using relatively inexpensive polymeric membrane materials and low-cost non-precious metal catalysts, have the potential to significantly lower the capital expenditure of an electrolyzer unit. Although this technology has great potential, scalable electrodes need to be developed for conducting electrochemical reactions efficiently. While traditional anion exchange membrane materials exhibit good ionic conductivity, unfortunately, incorporating them into devices involves challenges that lead to lower efficiency and poor durability. AEMELs also must overcome higher H₂ cross permeation at the higher differential pressures used in production devices. In addition, apart from materials level challenges, manufacturing approaches for membrane electrode assemblies also require innovation.

### SUMMARY

Recognizing the need for improved materials and manufacturing for AEMELs, the inventors of the present application have invented novel polymer materials, methods for producing such materials, and methods for incorporating such materials in electrolyzers, including water electrolyzers. The inventors of the present application have incorporated anion-exchange polymers that exhibit excellent durability and high current density in electrochemical applications such as electrolysis (of water, carbon dioxide, etc.), fuel cells, electrodialysis, etc. As discussed in more detail herein, the anion-exchange polymers of the present application directly address the need to improve electrode functionality in AEMELs.

Specifically, embodiments of the present application enable electrolyzers using anion exchange polymers that can be cross-linked with or without an organic or a metal-organic moiety, functionalized to form a quaternary ammonium group, which can be used as a membrane or an ionomer. Embodiments of the present application also enable a higher current density of 1.5+A/cm², durability of 1000+ of hours, and operation at very low concentrations (<100 mM) of an electrolyte such as KOH, K₂CO₃, KHCO₃, or even enable operation with pure DI water. Embodiments of the present application also can prevent substantially any H₂ or O₂ leakage to the opposite side of an electrolytic cell, keeping the amount of undesirable gas below 4% on the opposite side even at higher differential pressures. Embodiments of the present application can also be used in a membrane electrode assembly process by roll coating multiple layers of such polymers as catalyst ink layer(s) or polymer layer(s) sequentially using a multi-layered slot-die head or multiple slot-die heads in one coating line.

Thus, in one aspect, the present application provides approaches for incorporating anion-exchange polymers into electrodes and electrochemical devices. In some embodiments discussed herein, the anion-exchange polymers of the present application (discussed in more detail below) can be used as a membrane material. When used as a membrane material, the anion-exchange polymers may be called an anion-exchange membrane or AEM. In some embodiments discussed herein, the anion-exchange polymers of the present application can be used as an ionomer material. When used as an ionomer material, the anion-exchange polymers may be called an anion-exchange ionomer or AEI. In the context of the present application, such uses are not mutually exclusive, i.e., the anion-exchange polymer materials of the present application may be used as AEMs and AEIs.

Further objects, features, and advantages of the present application will become apparent from the detailed description of preferred embodiments which is set forth below, when considered together with the figures of drawing.

### BRIEF DESCRIPTION OF THE DRAWINGS

FIG. 1 depicts an embodiment of an electrolytic cell containing embodiments of the materials discussed herein.

FIG. 2 depicts an embodiment of a combustion/oxidation catalyst finely dispersed throughout an embodiment of a membrane.

FIG. 3 depicts an embodiment of a combustion/oxidation catalyst layer embedded within an embodiment of a membrane.

FIG. 4 depicts an embodiment of a combustion/oxidation catalyst layer between the membrane and the anode catalyst layer.

FIG. 5 depicts an embodiment of a combustion/oxidation catalyst layer dispersed in the anode catalyst layer.

FIG. 6 depicts an embodiment of a combustion/oxidation catalyst layer between an embodiment of the anode catalyst layer and anode substrate layers.

FIG. 7 depicts an embodiment of a combustion/oxidation catalyst layer in between the anode substrate layers.

FIG. 8 depicts an embodiment of a combustion/oxidation catalyst layer disposed at the edge of anode substrate layers.

FIG. 9 depicts an embodiment of a combustion/oxidation catalyst layer dispersed in the anode substrate layers.

FIG. 10 depicts an embodiment of an overview of polymer modification for enhanced activity or mechanics.

FIG. 11 depicts a schematic of a slot-die coating operation.

FIG. 12 depicts an embodiment of a multi-layer coatable slot-die head.

FIG. 13 depicts an embodiment in which a plurality of slot-die heads is used to coat a membrane.

FIG. 14 depicts embodiments in which a catalyst coated electrode using materials described in the present invention are assembled in a stack of two replicates to evaluate the voltage-current polarization curve scanned from 1.5+ to 0 A/cm² current density.

FIG. 15 depicts an embodiment of durability of the stack with 2 replicates of coated electrodes operated for ˜1000 h.

### DETAILED DESCRIPTION

The inventors of the present application have invented novel polymer membrane materials, methods for producing such materials, and methods for incorporating such materials in electrolyzers, including water electrolyzers. The inventors of the present application have developed anion-exchange polymers that exhibit excellent durability and high current density in electrochemical applications such as electrolysis (of water, carbon dioxide, etc.), fuel cells, electrodialysis, etc. As discussed in more detail herein, the anion-exchange polymers of the present application directly address the need for improvement in electrode functionality in AEMELs.

### Definitions

As used herein, the following definitions will apply unless otherwise indicated.

In the context of the present application, the term “ionomer” means a functional polymer that may or may not be cross-linked and contains a functional group that enables conduction of anions through itself, or which facilitates catalytic reactions.

In the context of the present application, the term “catalyst” means an element or a metal oxide or an organo-metallic complex that enables electrocatalytic reactions such as hydrogen evolution, oxygen evolution reactions or combustion reactions.

The term “unsaturated,” as used herein, means that a moiety has one or more units of unsaturation, whereas a “saturated” moiety has no units of unsaturation.

The term “organo-metallic” means a molecule that has metal ions bonded to organic ligand groups.

The term “ligand” means an organic molecule that is typically made of elements used in polymer or cross-linker and can bond to metallic groups which can then act as a catalyst.

The term “functional additive” means a molecule that consists of an organic molecule that can act as a cross-linker or conduct anions or can also act as a molecule that facilitates catalyst reactions.

In the context of the present application, use of essentially pure water in the context of an electrolytic cell refers to water having a concentration of liquid electrolyte less than 250 mM. AEMELs of the present application are preferably operated using essentially pure water. AEMELs of the present application are also capable of being operated with a liquid electrolyte concentration of less than 200 mM, 150 mM, 100 mM, 50 mM, 10 mM, or 1 mM.

### Anion Exchange Polymers

In one aspect, the present application provides novel anion exchange polymers for use in electrolytic cells, preferably water electrolyzers. In particular, the novel anion exchange polymers are particularly useful as membranes, or coating materials for electrodes in electrochemical devices, or as a filter media, etc.

An anion exchange polymer is a random and/or block copolymer having one or more types of monomer units that are optionally crosslinked. Typically, certain regions of the anion exchange polymer are hydrophobic while others are hydrophilic, as a result of the characteristics of the monomers comprising each region. Crosslinking is accomplished by way of a crosslinker, i.e., a molecule connecting two or more monomer units (hydrophilic and/or hydrophobic) via a chemical bond. The anion exchange polymer may also contain a charged or uncharged functional group attached to one or more monomer units. The polymer is optionally a random or block copolymer comprising but not limited to hydrocarbons. A general structure of an anion exchange polymer is shown below in in Formula I:

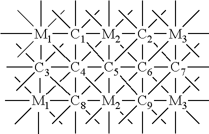

wherein:
each [symbol] represents an optional chemical bond, which may be a single or double bond, an ionic bond (or electrovalent bond), a hydrogen bond, or a polar covalent bond;
each Mₙ (with n≥2) represents a monomer unit, wherein each Mₙ is optionally of different type or class (hydrophilic, hydrophobic); and
each Cₙ (with n≥1) represents a cross-linker, wherein each Cₙ is optionally of a different type or class.

In certain embodiments of Formula I, an Mn may be directly bonded to an adjacent Mn such that there is no crosslink between the two monomer units. In some embodiments, a monomer unit may be connected to an adjacent monomer unit directly and to another monomer unit via a cross-linker.

With respect to the anion exchange polymer of Formula I shown above, each monomer unit Mₙ may contain C, H, N, F, Cl, Br, and/or I atoms. In some instances, the monomer unit is selected from the group consisting of:

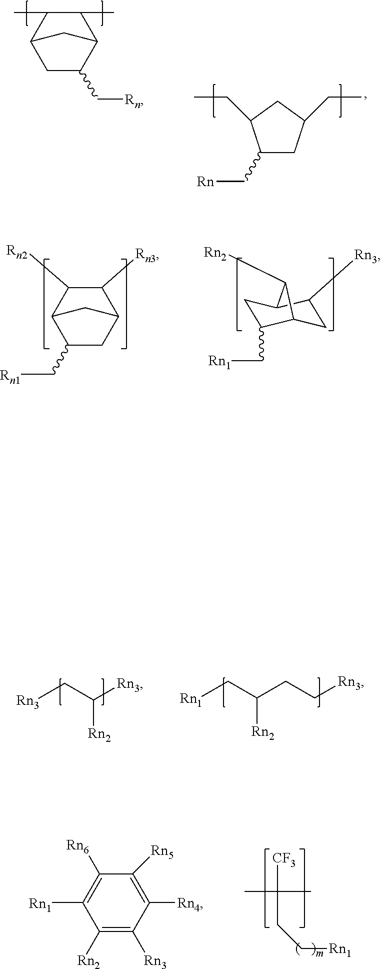

wherein Rn, Rn₁, Rn₂, Rn₃, Rn₄, Rn₅, and Rn₆ are defined as in Formula II through VII below.

With respect to the anion exchange polymer of Formula I, the monomer units Mₙ may each be optionally connected to another monomer unit via a cross-linking chemical, or crosslinker. In some instances, the crosslinker is selected from the group consisting of:

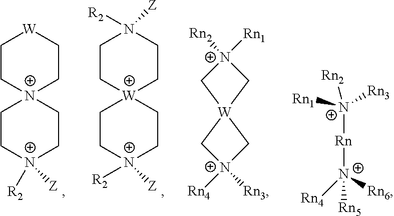

wherein W, Z, R₂, Rn, Rn₁, Rn₂, Rn₃, Rn₄, Rn₅, and Rn₆ are defined as in Formula II through VII below.

With respect to the anion exchange polymer for Formula I, the monomer units Mₙ may each be connected to a functional group that can conduct anions. In some instances, the functional group is selected from the group consisting of:

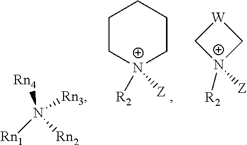

wherein W, Z, R₂, Rn₁, Rn₂, Rn₃, and Rn₄ are defined as in Formula II through VII below.

In the context of the present application, the block or random co-polymers discussed herein are macro-molecules capable of being engineered to enable certain desired characteristics, such as ion conduction, without sacrificing mechanical properties. Each monomer unit or block can be designed as per the hydrophobicity and hydrophilicity to enable phase segregation, which, in the context of water electrolyzers, improves anion conduction in ionic pathways of hydrophilic blocks while maintaining overall mechanics due to hydrophobic blocks.

In some embodiments, the multiblock copolymers of the present application may include a plurality of blocks (for example, 2, 3, 4, 5, 6, 7, 8, 9, 10, or more), wherein each block is either hydrophilic or hydrophobic. In some embodiments, the blocks include hydrophilic and/or hydrophobic regions. In some embodiments, the blocks are based on norbornene-, alkene-, or fluorocarbon-based monomers. In some embodiments, the multiblock copolymers may comprise one or more norbornene-based hydrophobic blocks and one or more norbornene-based hydrophilic blocks. In some embodiments, the multiblock copolymer may also include one or more norbornene-based hydrophilic blocks and one or more alkene-based hydrophobic blocks. In some embodiments, the multi-block copolymer may include 2 to 8 blocks. In some embodiments, the hydrophobic and hydrophilic blocks are alternately placed in an (A-B) n or A-(B-A) n or B-(A-B) n arrangement. In some embodiments, the multi-block copolymer comprises an all-hydrocarbon backbone. In some embodiments, the multi-block copolymer may also include a fluorocarbon-based backbone.

In embodiments of the present application, the amount of hydrophilic groups in the copolymer can vary. In some embodiments, the copolymer includes 30 to 40 mol % of the hydrophilic groups, wherein the remaining groups are hydrophobic. In some embodiments, the copolymer includes 40 to 50 mol %, wherein the remaining groups are hydrophobic. In some embodiments, the copolymer includes 50 to 60 mol %, wherein the remaining groups are hydrophobic. In some embodiments, the copolymer includes 60 to 70 mol %, wherein the remaining groups are hydrophobic. In some embodiments, the copolymer includes 70 to 80 mol %, wherein the remaining groups are hydrophobic. In some embodiments, the copolymer includes 90 to 99 mol %, wherein the remaining groups are hydrophobic.

In some embodiments, the anion exchange polymer of the present application is of Formula II:

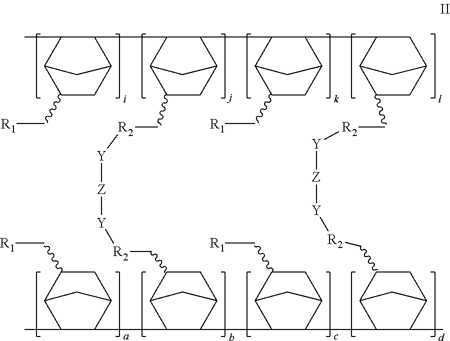

wherein:
   i, j, k, l, a, b, c, and d are each independently between 1 to 1000, wherein the regions defined by the repeating units i, j, k, l, a, b, c, and d are each a block in the anion exchange polymer;
   R₁ and R₂ are each independently a substituted or unsubstituted, branched or unbranched, C₁-C₂₀ aliphatic or heteroaliphatic;
   Y is independently a quaternary aliphatic or heterocyclic amine; and
   Z is independently a crosslinking group, wherein the crosslinking group Z is optionally present in each block.

In some embodiments, R₁ is a C₁-C₂₀ aliphatic or heteroaliphatic containing halogenated groups such as Cl, Br, I, and F.

In some embodiments, Y is N⁺R, where R is a saturated aliphatic or heterocyclic group (for example, N⁺(C₅H₁₀) or a quaternary ammonium spirocyclic group (for example, N⁺(C4H10)-N⁺(C₅H₁₀)).

In some embodiments, the anion exchange polymer of the present application is of Formula III:

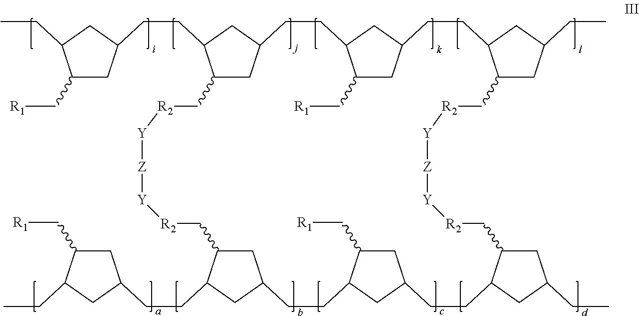

wherein:
   i, j, k, l, a, b, c, and d are each independently between 1 to 1000, wherein the regions defined by the repeating units i, j, k, l, a, b, c, and d are each a block in the anion exchange polymer;
   R₁ and R₂ are each independently a substituted or unsubstituted, branched or unbranched, C₁-C₂₀ aliphatic or heteroaliphatic;
   Y is independently a quaternary aliphatic or heterocyclic amine; and
   Z is independently a crosslinking group, wherein the crosslinking group Z is optionally present in each block.

In some embodiments, R₁ is a C₁-C₂₀ aliphatic or heteroaliphatic containing halogenated groups such as Cl, Br, I, and F.

In some embodiments, Y is N⁺R, where R is a saturated aliphatic or heterocyclic group (for example, N⁺(C₅H₁₀) or a quaternary ammonium spirocyclic group (for example, N⁺(C4H10)-N⁺(C₅H₁₀)).

In some embodiments, the anion exchange polymer of the present application is of Formula IV:

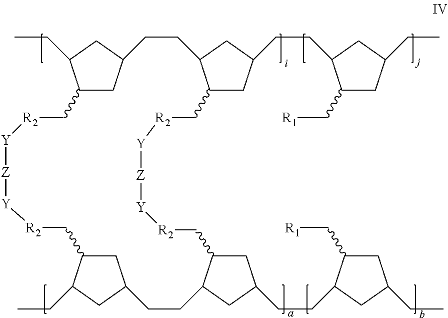

wherein:
   i, j, a, and b are each independently between 1 to 1000, wherein the regions defined by the repeating units i, j, a, and b are each a block in the anion exchange polymer;
   R₁ and R₂ are each independently a substituted or unsubstituted, branched or unbranched, C₁-C₂₀ aliphatic or heteroaliphatic,
   Y is independently a quaternary aliphatic or heterocyclic amine, and
   Z is independently a crosslinking group, wherein the crosslinking group Z is optionally present in each block.

In some embodiments, R₁ is a C₁-C₂₀ aliphatic or heteroaliphatic containing halogenated groups such as Cl, Br, I, and F.

In some embodiments, Y is N⁺R, where R is a saturated aliphatic or heterocyclic group (for example, N⁺(C₅H₁₀) or a quaternary ammonium spirocyclic group (for example, N⁺(C4H10)-N⁺(C₅H₁₀)).

In some embodiments, the anion exchange polymer of the present application is of Formula V:

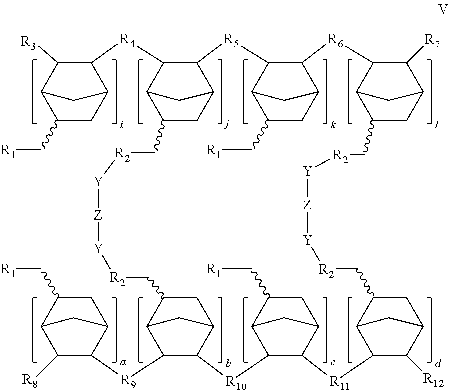

wherein:
   i, j, k, l, a, b, c, and d are each independently between 1 to 1000, wherein the regions defined by the repeating units i, j, k, l, a, b, c, and d are each a block in the anion exchange polymer;
   R₍ₙ₎ where n=1 to 12 are each independently a substituted or unsubstituted, branched or unbranched, C₁-C₂₀ aliphatic or heteroaliphatic,
   Y is independently a quaternary aliphatic or heterocyclic amine, and
   Z is independently a crosslinking group, wherein the crosslinking group Z is optionally present in each block.

In some embodiments, R₁ is a C₁-C₂₀ aliphatic or heteroaliphatic containing halogenated groups such as Cl, Br, I, and F.

In some embodiments, Y is N⁺R, where R is a saturated aliphatic or heterocyclic group (for example, N⁺(C₅H₁₀) or a quaternary ammonium spirocyclic group (for example, N⁺(C4H10)-N⁺(C₅H₁₀)).

In some embodiments, the anion exchange polymer of the present application is of Formula VI:

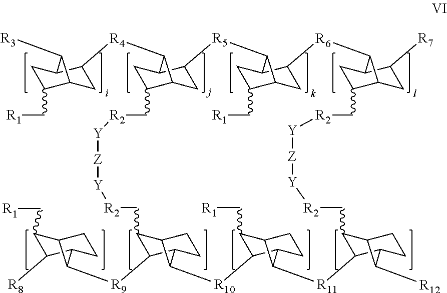

wherein:
   i, j, k, l, a, b, c, and d are each independently between 1 to 1000, wherein the regions defined by the repeating units i, j, k, l, a, b, c, and d are each a block in the anion exchange polymer;
   R₍ₙ₎ where n=1 to 12 are each independently a substituted or unsubstituted, branched or unbranched, C₁-C₂₀ aliphatic or heteroaliphatic,
   Y is independently a quaternary aliphatic or heterocyclic amine, and
   Z is independently a crosslinking group, wherein the crosslinking group Z is optionally present in each block.

In some embodiments, R₁ is a C₁-C₂₀ aliphatic or heteroaliphatic containing halogenated groups such as Cl, Br, I, and F.

In some embodiments, Y is N⁺R, where R is a saturated aliphatic or heterocyclic group (for example, N⁺(C₅H₁₀) or a quaternary ammonium spirocyclic group (for example, N⁺(C4H10)-N⁺(C₅H₁₀)).

In some embodiments, the anion exchange polymer of the present application is of Formula VII:

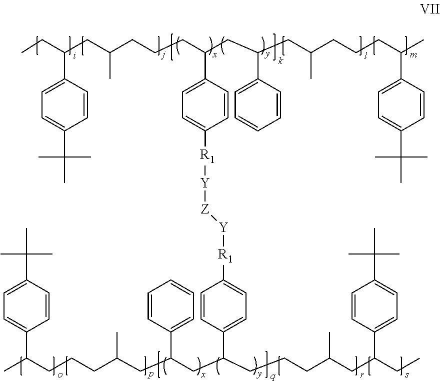

wherein:
   i, j, k, l, a, b, c, d, x and y are each independently between 1 to 1000, wherein the regions defined by the repeating units i, j, k, l, a, b, c, d, x, and y are each a block in the anion exchange polymer;
   R₁ is each independently a substituted or unsubstituted, branched or unbranched, C₁-C₂₀ aliphatic or heteroaliphatic,
   Y is independently a quaternary aliphatic or heterocyclic amine, and
   Z is independently a crosslinking group, wherein the crosslinking group Z is optionally present in each block.

In some embodiments, R₁ is a C₁-C₂₀ aliphatic or heteroaliphatic containing halogenated groups such as Cl, Br, I, and F.

In some embodiments, Y is N⁺R, where R is a saturated aliphatic or heterocyclic group (for example, N⁺(C₅H₁₀) or a quaternary ammonium spirocyclic group (for example, N⁺(C4H10)-N⁺(C₅H₁₀)).

With respect to Formula II through Formula VII, in some embodiments, Y is selected from the group consisting of

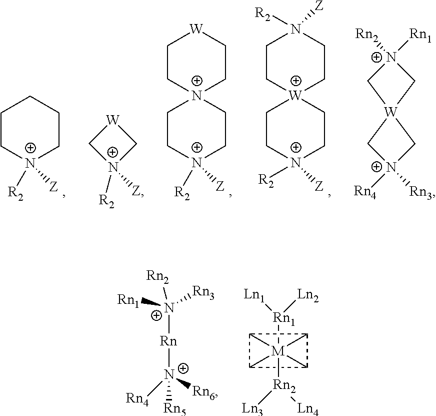

wherein:
   R₂ and Rₙ is a substituted or unsubstituted, branched or unbranched, C₁-C₂₀ aliphatic or heteroaliphatic group,
   Z is defined as above with respect to Formula II through Formula VII,
   W is either
      a C₁-C₂₀ aliphatic or heteroaliphatic such that Y comprises a single heterocyclic group, or
      1-20 independent C₄-10 homocyclic or heterocyclic groups connected with N⁺; and
   each Rₙ₍ᵢ₎ is H or a carbon-containing moieties, with i≥1 (e.g. Rₙ₁, Rₙ₂, etc.).

In some embodiments, Y acts as a cross-linking bridge between one block of polymer to another block of polymer.

In some embodiments, Z is a substituted or unsubstituted, branched or unbranched, C₁-C₂₀ aliphatic or heteroaliphatic. In some embodiments, Z is [(R₃)ₓN⁺(R₄)_{y}]_{q}, wherein R₃ and R₄ are alkyl spacer chains, wherein each spacer chain is a substituted or unsubstituted, branched or unbranched, C₁-C₂₀ alkyl, and wherein q ranges from 1 to 10. In some embodiments, Z is [(R₃) N⁺(R₄) (R₅)]ᵣ, wherein R₃, R₄ are alkyl spacer chains, wherein each spacer chain is a substituted or unsubstituted, branched or unbranched, C₁-C₂₀ alkyl, R₅ is heterocyclic or spirocyclic entity attached to quaternary ammonium molecule, and wherein r ranges from 1 to 10.

It will also be understood that each crosslinking group Z may crosslink to an independent polymer chain.

In some embodiments, Y is a metal-organic complex where Rₙ, Rₙᵢ where i=1 to 99 could be H or other atoms containing carbon. In some embodiments, the metal complex includes a metal atom/molecule-M in a coordination bond with another organic molecule which may contain but not be limited to C, H, N, O, F, and S atoms. In some embodiments, M also could contain one or more of metal groups such as Co, Fe, Ni, Pt, Ru, Ir, Mo, Ce, Mn, Cu, Si. In some embodiments, Lₙᵢ, where I=1 to 99, is a ligand molecule that forms a coordination bond with the metal complex as well as connects to the polymer backbone. The ligand molecule contains but is not limited to C, H, N, O, F, and S atoms. One example of such metal-organic complex is but not limited to the following molecule:

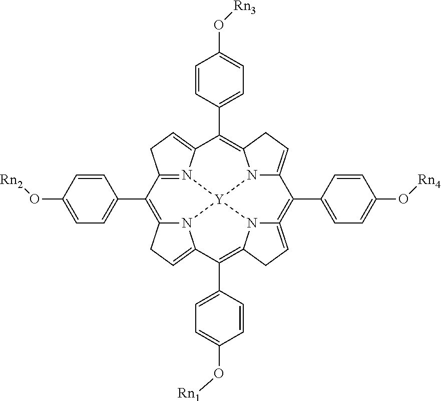

wherein
   each Rₙ₍ᵢ₎ is H or a carbon-containing moieties, with i≥1 (e.g. Rₙ₁, Rₙ₂, etc.);
   Y is a metal group, such as Ni, Fe, Pt, Ru, Ir, Mo or Co.

In some embodiments, each block defined by i, j, k, l, a, b, c, and d in the foregoing formulas II through VII has a degree of crosslinking between 0% and 100%, wherein the degree of crosslinking represents the number of monomers in the block i, j, k, l, a, b, c, and d that are crosslinked to a monomer of another block. In some embodiments, the degree of crosslinking is between 1% to 50%. Where a monomer is not crosslinked to another monomer, the crosslinking group Z may be absent, or may be partially or wholly present without forming a chemical bond to another monomer.

### Cross Linkers

As discussed above, in some embodiments, the multi-block copolymers of the present application are cross-linked with a cross-linker. As will be understood by one of skill in the art, cross-linking bonds are bonds (typically one or more covalent bonds) between individual polymer chains that join such chains together—and in this way, may give rise to macromolecules having multiple blocks. In some embodiments of the present application, the degree of cross-linking and hydrophobic groups within the polymer may be modified to tune the water uptake and mechanical properties. Generally, a greater degree of cross-linking increases chain compaction and restricts swelling when a multi-block copolymer is exposed to water (such as in an electrolyzer).

In some embodiments, the cross-linker may contain functional groups that can conduct anions, in particular 1, 2, 3, 4, 5, 6, 7, 8, 9, 10, or more cations. In some embodiments, the cross-linker may not include any cationic functional groups. In some embodiments, the cross-linker may consist of 2 or more chemical bonds forming reactive sites. In some embodiments, suitable chemical bond-forming reactive sites on a cross-linker can include (but are not limited to) nucleophilic groups such as amines. In some embodiments, the cross-linker is an organometallic compound that consists of organic covalent bonds as well as inorganic metal atoms or molecules. In some embodiments, the cross-linker is also catalytically active, for e.g., Oxygen Evolution Reaction (OER) or Hydrogen Evolution Reaction (HER).

In some embodiments, the cross-linker is one or more heterocyclic or spirocyclic multi-amines connected via either a C₂₋₂₀ alkyl spacer chain or heterocyclic or spirocyclic member rings connected via a hetero-atom such as N. In some embodiments, the number of atoms in the heterocyclic ring may be 4 to 20, which includes both carbon and nitrogen atoms (or other heteroatoms). In some embodiments, the member rings may consist of atoms other than C, H, and N. In some embodiments, the cross-linker may be heterocyclic or spirocyclic quaternary ammoniums connected via a hetero atom such as (but not limited to) N atoms on either end of the ring (as shown in some embodiments above). Exemplary cross-linking agent examples include, but are not limited to, 1,1′-(1,6-Hexanediyl) dipiperidine.

In some embodiments, the cross-linker is a molecule with one or more amine groups. In some embodiments, the amine groups are optionally situated on terminal positions. In some embodiments, the crosslinker is a molecule containing (but not limited to) C, H, N, O, F, S atoms.

Thus, in some embodiments, the cross-linker has one of the following chemical structures:

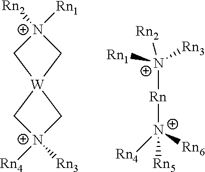

wherein:
   each Rₙ₍ᵢ₎ is H or a carbon-containing moieties, with i≥1 (e.g. Rₙ₁, Rₙ₂, etc.);
Rn is a substituted or unsubstituted, branched or unbranched, C₁-C₂₀ aliphatic or heteroaliphatic group,
W is a saturated or unsaturated, branched or unbranched, substituted or unsubstituted, C₁-C₉₉ hydrocarbon chain, optionally containing one or more heteroatoms (such as N, S, or O).

In some embodiments, the cross-linker contains an organometallic (metal-organic) complex. In preferred embodiments, the molecule thus possesses electrocatalytic activity. In some embodiments, the cross-linker has the following structure:

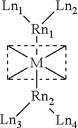

wherein:
   each Rₙ₍ᵢ₎ is H or a carbon-containing moiety, with i≥1 (e.g. Rₙ₁, Rₙ₂, etc.);
   M is an organometallic complex comprising a metal atom or metallic molecule in a coordination bond with an organic molecule or atoms, wherein the organic molecule optionally contains C, H, N, O, F, and/or S atoms and/or the organic atoms are C, H, N, O, F, and/or S, wherein the Metal of M is optionally Co, Fe, Ni, Pt, Ru, Ir, Mo, Ce, Mn, Cu, or Si;
   each Lₙ₍ᵢ₎ is a ligand molecule that forms a coordination bond with the metal complex as well as connects to the polymer backbone; with i≥1 (e.g. Lₙ₁, Lₙ₂, etc.),
wherein the ligand molecule contains but is not limited to C, H, N, O, F, and S atoms,
wherein the ligand molecule can be connected to one or more monomer units which may be hydrophilic or hydrophobic,
   wherein Rₙ₍ᵢ₎ may be optionally omitted and one or more of Lₙ₍ᵢ₎ bonds directly with M.

In some embodiments, the polymer includes suitable functional groups to promote cross-linking with the cross-linker. In some embodiments, the functional group can include (but is not limited to) an electrophilic carbon atom, which bonds to an electronegative atom, such as a halogen (e.g., Cl, Br, F, I), sulfonate (e.g., mesylate, triflate, tosylate), oxygen, or nitrogen. The electrophilic group on the copolymer undergoes a nucleophilic substitution reaction with the cross-linking agent, which consists of a nucleophilic functional group such as an amine group (—NR₂, where R is H, alkyl, heterocyclic, or spirocyclic molecule) to cross-link the co-polymers. The amount of cross-linking can be controlled by selecting the desired amount of cross-linking agent. The extent of cross-linking can be decided by the stoichiometry of the cross-linker. The mole % of the cross-linking agent can be 1% or more based on total moles of sites available for the reaction. The amount of cross-linking can be from about 1% to 50%.

### Functional Additives

In some embodiments, the polymer includes a functional additive that is a tertiary amine, for example N(CH₃)₃, or a heterocyclic amine, for example N-methyl piperidine. In some embodiments, the tertiary amine is one of the following:

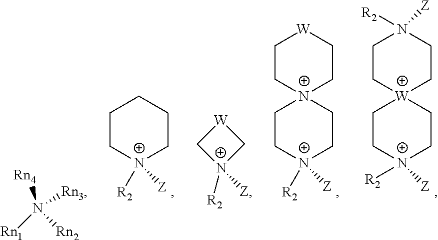

wherein:
   each Rₙ₍ᵢ₎ is H or a carbon-containing moiety, with i≥1 (e.g. Rₙ₁, Rₙ₂, etc.);
   R₂ is as defined above;
   Z is a crosslinking group, wherein the crosslinking group Z is optionally present in each block;
   W is either
      a C₁-C₂₀ aliphatic or heteroaliphatic such that functional additive comprises a single heterocyclic group, or
      1-20 independent C₄₋₁₀ homocyclic or heterocyclic groups connected with N⁺.

In one embodiment, the present application provides a method for making a cross-linked block copolymer comprising one or more hydrophilic blocks and one or more hydrophobic blocks. In certain embodiments, the method provides a method to make such copolymers with a cross-linking agent of a desired mol %. In some embodiments, the cross-linking agent is a multi-heterocyclic or spirocyclic amine attached with either a C₁-C₂₀ alkyl or cyclical group chain. The one or more hydrophilic monomer units in the copolymer comprise a saturated C₁-C₂₀ halogenated alkyl chain. The alkyl chain may contain at least one or more electrophilic carbon atoms. In some embodiments, the crosslinked copolymer comprises a crosslinker having one or more saturated C₂-C₂₀ alkyl chains branched/unbranched or a heterocyclic or spirocyclic chain bound to one or more cationic head groups of one or more norbornene based hydrophilic monomers. For example, in some embodiments, the crosslinked copolymer comprises a crosslinker group with C₃ to C₉ alkyl chain. In some embodiments, multiple cationic head groups exist on the crosslinker spaced either by C₃-C₉ saturated alkyl chain or a heterocyclic or spirocyclic chain of quaternary ammonium groups. In some embodiments the cationic head groups of one or more norbornene-based hydrophilic monomers are crosslinked with each other via an alkyl spacer chain crosslinker or via a heterocyclic or spirocyclic chain. The concentration of the cross-linker in the copolymer can vary. The concentration can vary between 1 to about 50 mol %.

### Anion Exchange Membranes and Ionomers

In some embodiments of the present application, the polymer materials discussed herein are used in anion exchange membranes (AEM) and ionomer materials (AEI). Thus, one aspect of the present application comprises an anion exchange membrane consisting of the copolymer of the present application. In some embodiments, the AEM of the present application comprises one or more non-crosslinked multiblock copolymers as described herein. In some embodiments, the AEM of the present application comprises hydrophobic and hydrophilic regions within the polymer and/or AEM, which form due to phase segregation within the block polymers. The phase segregation leads to the formation of anion-conducting pathways. In some embodiments, the AEM has an ion exchange capacity in the range of 0.1 to above 8.0.

In some embodiments, the AEM of the present application comprises one or more crosslinked multiblock copolymers described herein. In some embodiments, the AEM of the present application comprises hydrophobic and hydrophilic regions within the polymer and/or AEM, which form due to phase segregation within the block polymers. The phase segregation leads to the formation of anion-conducting pathways. In some embodiments, the AEM has an ion exchange capacity in the range of 0.1 to above 8.0.

Integrating catalysts to mitigate H₂ or O₂ leak across either of the compartments.

In an electrolytic cell, as hydrogen is the smallest molecule in the known universe, in practice hydrogen gas may leak across the membrane from cathode to anode compartment, which leak is undesirable and potentially hazardous for reasons that will become apparent. Similarly, oxygen which gets generated at the anode compartment may also leak through the membrane into the cathode compartment, which again can present danger. These hydrogen and/or oxygen leaks can give rise to a situation where the gas exiting the electrolytic device is a mixture of hydrogen and oxygen gas. This mixture is potentially hazardous depending on the ratio of hydrogen in the mixture, which increases the safety concerns about the device. The flammability of hydrogen is 4 to 94% in air and 4 to 94% for oxygen, meaning both the hydrogen or oxygen product streams could be combustible if too much leakage is present. The inventors of the present application propose novel modifications to the current state of the art which will mitigate the leak of these two gasses across the membrane.

In some embodiments, the proposed modifications involve membrane electrode assembly comprising a catalyst which can conduct a combustion reaction between H₂ and O₂ on its surface to remove any leaked gas from the final product stream, or else reduce the concentration of the leaked gas to levels insufficient to permit combustion. The combustion reaction catalyzed can also be termed as hydrogen oxidation reaction. The reaction is as follows:

$${H}_{2} + {O}_{2} \to {H}_{2} O \qquad ( 1 )$$

Here, the combustion catalyst can facilitate the reaction when one or both reactants are in gas and/or dissolved aqueous state.

Additionally, the catalyst can also facilitate the oxidation reaction as follows:

$$2 {H}_{2} + 4 {OH}^{-} \to 4 {H}_{2} O + 4 {e}^{-} \qquad ( 2 )$$

In some embodiments, the catalysts used to enable reaction (1) & (2) are single atom based. In some embodiments, the catalyst is a precious or non-precious metal, for example—Pt, Pd, Ni, Fe, Ag, Bi, Cr, Ce, Ge, Mo, Mg, Mn, Co, Ti, Al, Cu, Ir, In, Nb, Rh, Re, Si, Sn, Sb, Sm, Se, Te, Tb, Tm, Ta, V, W, Y, Yb, Zn, Zr, Ru, etc. In some embodiments, the catalyst is an oxide form of metal such as PtO, PdO, NiO, MgO, CoO, Co₂O₃, Co₃O₄, Cr₂O₃, CuO, Cu₂O, Cu(OH)₂, Dy₂O₃, Er₂O₃, Eu₂O₃, FeOOH, Fe₂O₃, Fe₃O₄, Fe(OH)₃, GdO₃, HfO₂, In₂O₃, In(OH)₃, La₂O₃, Mg(OH)₂, MoO₂, MoO₃, MnO₂, Mn₂O₃, Mn₃O₄, Nd₂O₃, Ni(OH)₂, Ni₂O₃, Ni₃O₄, Sb₂O₃, SiO₂, Sm₂O₃, SnO₂, Tb₄O₇, Co₃O₄, TiO₂, Al₂O₃, Al(OH)₃, Bi₂O₃, CeO₂, WO₃, W₂₀O₅₈, WO₄H₂, V₂O₅, Y₂O₃, ZnO, ZnCO₃, ZrO₂, Zr(OH)₄, CuO, IrO₂, etc. In some embodiments, the catalyst is a multi-element oxide such as BaFe₁₂O₁₉, BaTiO₃, CoFe₂O₄, MnFe₂O₄, MgAl₂O₄, NiFe₂O₄, Ni_{0.5}Zn_{0.5}Fe₂O₄, Ni_{0.5}Co_{0.5}Fe₂O₄, Srfe₁₂O₁₉, SrTiO₃, Y₃Al₅O₁₂, ZnFe₂O₄, Zn_{0.5}Co_{0.5}Fe₂O₄, Zn_{0.5}Mn_{0.5}Fe₂O₄, Zr_{0.2}BaTi_{0.8}O₃, Al₂O₅Ti, AlCeO₃, BaTiO₃, SrTiO₃, CoAl₂O₄, Ce_{0.5}Zr_{0.5}O₂, CoNiO₂, C₃₂H₁₆CuN₈, ZrO₂Y₂O₃, etc. In some embodiments, the catalyst is supported on a support such as carbon, or oxide supports such as graphene oxide, TiO₂, or any other metal supports, etc. In some embodiments, the catalyst is an inorganic metal compound containing phosphides, nitrates, sulfides, hydroxides, carbonates, bicarbonates, nitrides, cyanides, iso-cyanides, silicide, carbide, borides, sulfates, fluorides, fluorates, silicate, etc. of any metal mentioned above or their combinations. In some embodiments, the catalyst is in ionic form which can later be in-situ reduced within the cell components. In some embodiments, the catalyst is a metallo-organic compound which is described in previous sections. The metallo-organic compound can be integrated as a cross-linker, as described in previous sections. In some embodiments, the catalyst is a multi-metallic alloy with any combination of the above-mentioned catalyst, example—PtNi, etc.

According to the present application, the catalyst can be located in any or all of the following components: membrane (polymer phase), anode catalyst layer, anode substrate layers, cathode catalyst layer, hydrogen manifolds, water/oxygen manifolds, water plenums, and cathode substrate layers. Illustrative, non-limiting examples of MEA architecture with the catalyst are as follows:

### Example: Catalyst Dispersed Throughout the Membrane

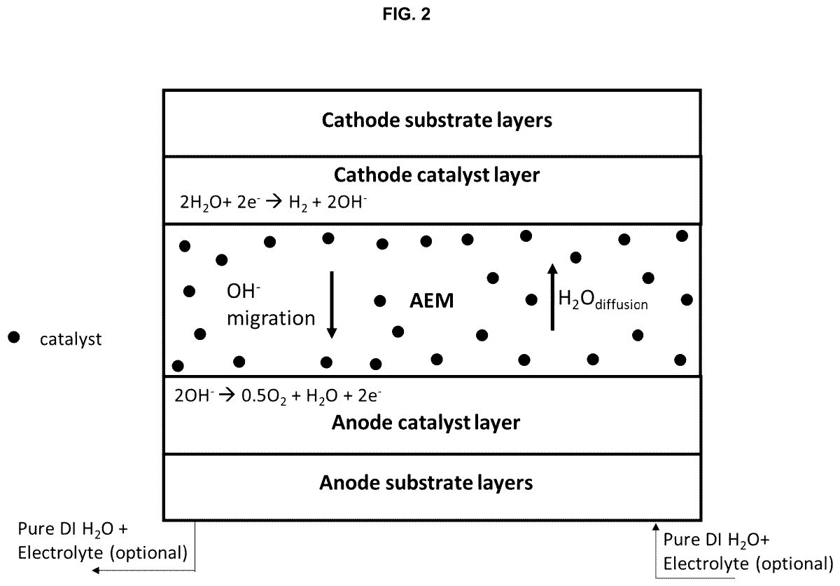

The present application also provides a method of making a membrane with finely dispersed catalyst, as well as the resulting structure (FIG. 2). In some embodiments, the catalyst can be incorporated into a polymer solution pre-casting, which will be in a liquid solution form. The catalyst and polymer solution could also be mixed by high-shear or sonication techniques.

### Example: Catalyst Layer Embedded within the Membrane

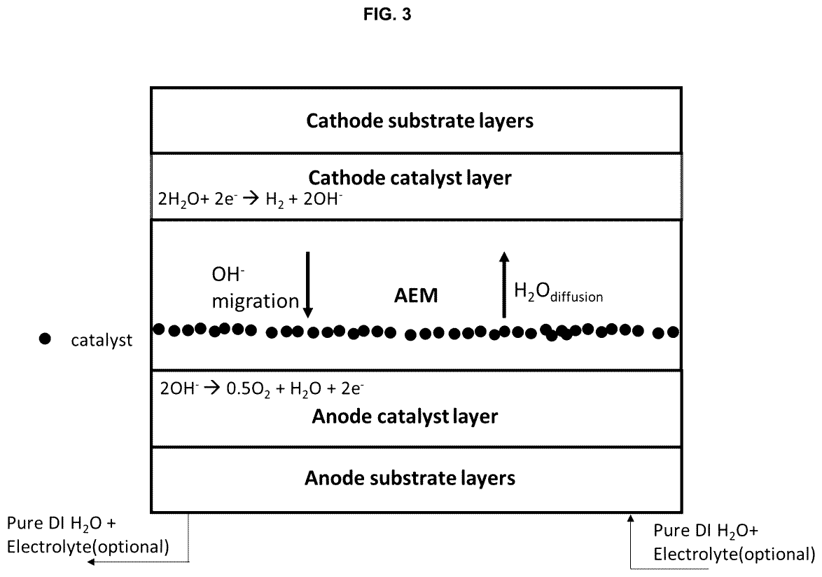

The present application also provides a method of making a membrane having an embedded catalyst layer, as well as the resulting structure (FIG. 3). In some embodiments, the catalyst layer thickness can be anywhere between 0 to X um, where X represents the total thickness of the membrane. The catalyst layer can be positioned anywhere across the membrane, for example closer to cathode, or in the center, or closer to anode. In some embodiments, the layer is approximately equidistant from the cathode and the anode. In some embodiments, the layer is closer to the cathode than the anode. In some embodiments, the layer is closer to the anode than the cathode.

In some embodiments, the catalyst layer may be introduced into a membrane by forming an ink (catalyst and binder) to coat on the membrane using techniques such as but not limited to slot-die coating, spray-coating, doctor blading, dip coating, screen-printing, gravure drum, rod-coating, etc. Then, the coated surface can be dried with or without methods such as heating, convection flow, or vacuum. Then, an additional layer of anion exchange polymer is deposited on top of the coated catalyst layer and dried to form a membrane with the catalyst layer embedded within itself.

### Example: Catalyst Layer Between Membrane and Anode/Cathode Catalyst Layer

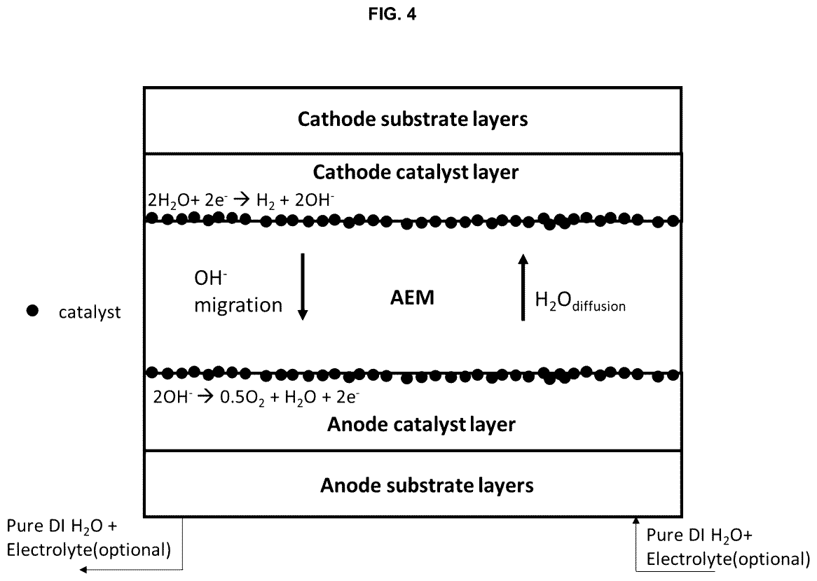

The present application also provides a method of providing catalyst layer between the membrane and the anode/cathode catalyst layer, as well as the resulting structure (FIG. 4). In some embodiments, a layer may be introduced between the membrane and the anode/cathode catalyst layer by forming an ink (catalyst+binder) to coat on the membrane using techniques such as but not limited to slot-die coating, spray-coating, doctor blading, dip coating, screen-printing, gravure drum, rod-coating, etc. Then, the coated surface may be dried with or without methods such as heating, convection flow, or vacuum. Alternatively, the catalyst layer can also be coated on top of the anode/cathode substrate instead of the membrane.

### Example: Catalyst Layer Dispersed Throughout the Anode Catalyst Layer

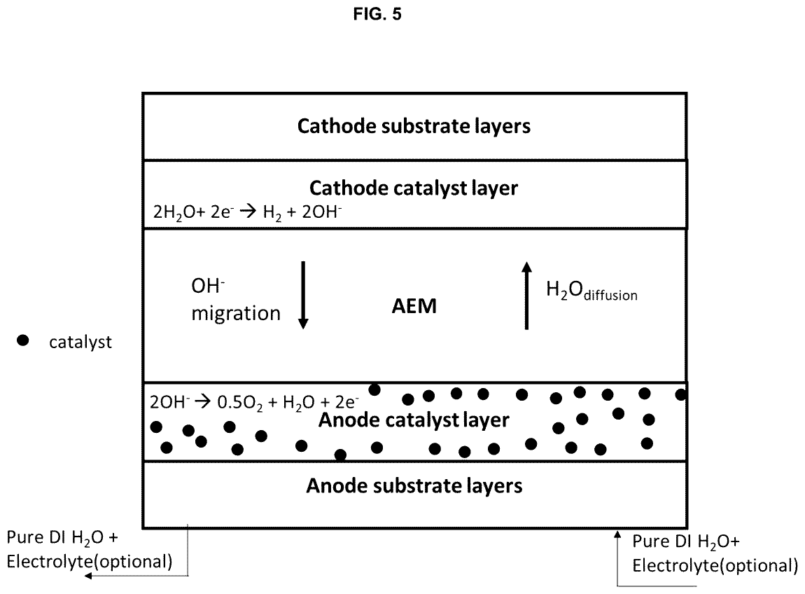

The present application also includes a method of providing a catalyst layer dispersed throughout the anode catalyst layer, as well as the resulting structure (FIG. 5). In some embodiments, the catalyst may be dispersed within the anode catalyst layer by forming an ink (catalyst+anode catalyst+binder and/or AEI) to coat on the membrane using techniques including but not limited to slot-die coating, spray-coating, doctor blading, dip coating, screen-printing, gravure drum, rod-coating, etc. Then, the coated surface can be dried with or without methods such as heating, convection flow, or vacuum. Alternatively, the ink can also be coated on top of the anode substrate layers instead of the membrane.

### Example: Catalyst Layer Between the Anode Catalyst Layer and Anode Substrate Layers

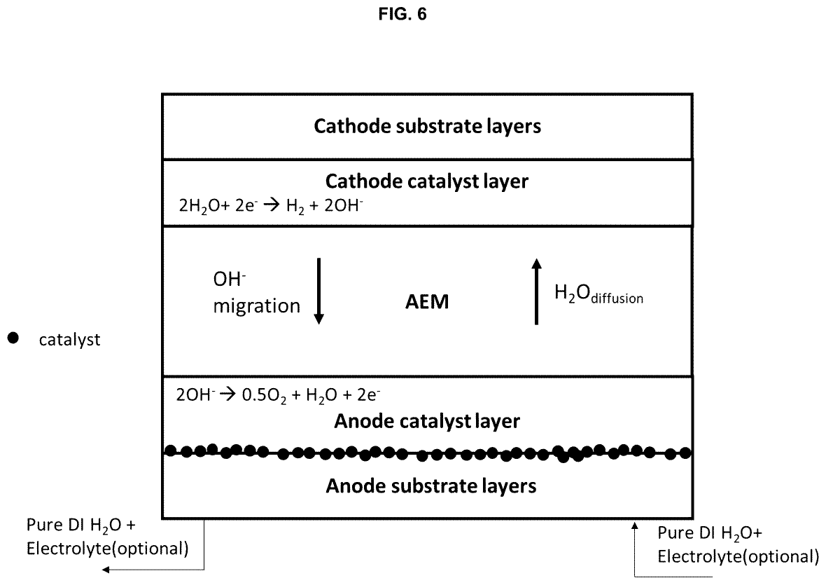

The present application also includes a method of providing a catalyst layer between the anode catalyst layer and anode substrate layer, as well as the resulting structure (FIG. 6). In some embodiments, the catalyst may be introduced between the anode catalyst layer and anode substrate layer by forming an ink (catalyst+binder) to coat on the anode substrate layers using techniques including but not limited to slot-die coating, spray-coating, doctor blading, dip coating, etc. Then, the coated surface can be dried with or without methods such as heating, convection flow, or vacuum. Following this, the dried surface can be coated with a standard anode catalyst layer using techniques mentioned above. Alternatively, the catalyst layer can also be deposited using other techniques such as chemical vapor deposition, atomic layer deposition, electrochemical deposition, etc.

### Example: Catalyst Layer in Between the Anode Substrate Layers

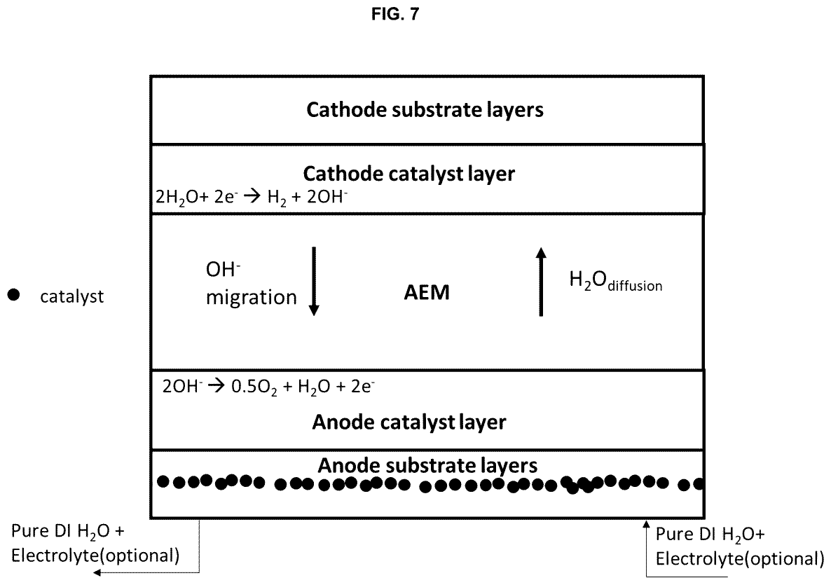

The present application also includes a method for providing a catalyst layer in between the anode substrate layers, as well as the resulting structure (FIG. 7). In some embodiments, the catalyst may be introduced in between the anode substrate layers by forming an ink (catalyst+binder) to coat on the anode substrate layer using techniques including but not limited to slot-die coating, spray-coating, doctor blading, dip coating, etc. Then, the coated surface can be dried with or without methods such as heating, convection flow, or vacuum. Alternatively, the catalyst layer can also be deposited using other techniques such as chemical vapor deposition, atomic layer deposition, electrochemical deposition, thermochemical deposition etc. If anode substrate layers consist of X total layers, then the catalyst layer can be in between either of layers, on top, bottom, or within the layer, or on all layers. Here X corresponds to anywhere between 0 to 100.

### Example: Catalyst Layer at the Edge of Anode Substrate Layers

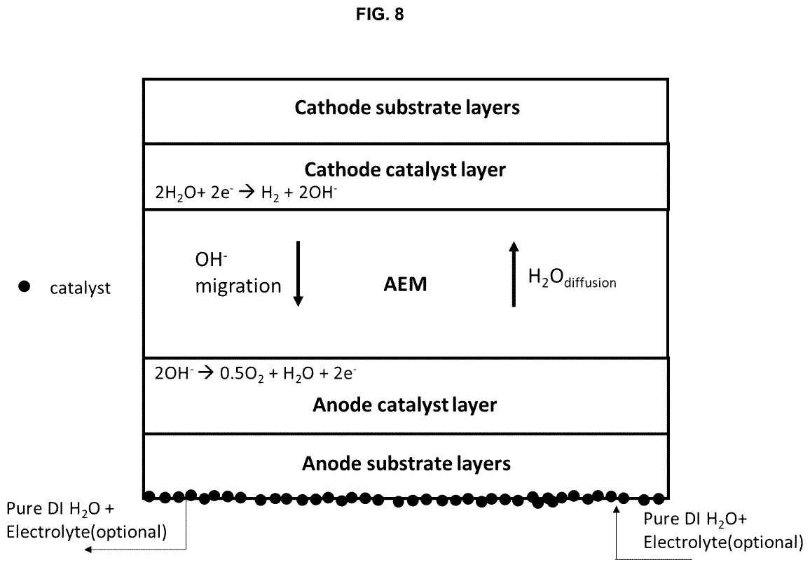

The present application also includes a method for providing a catalyst layer at the edge of the anode substrate layers, as well as the resulting structure (FIG. 8). In some embodiments, the layer may be introduced at the edge of the anode substrate layer by forming an ink (catalyst+binder) to coat at the edge of the anode substrate layer using techniques such as but not limited to slot-die coating, spray-coating, doctor blading, dip coating, etc. Then, the coated surface can be dried with or without methods such as heating, convection flow, or vacuum. The catalyst layer can also be deposited using other techniques such as chemical vapor deposition, atomic layer deposition, electrochemical deposition, etc. The catalyst layer can also be deposited on the surface that is immediately in contact with the substrate layers.

### Example: Catalyst Layer Dispersed Through the Anode Substrate Layers

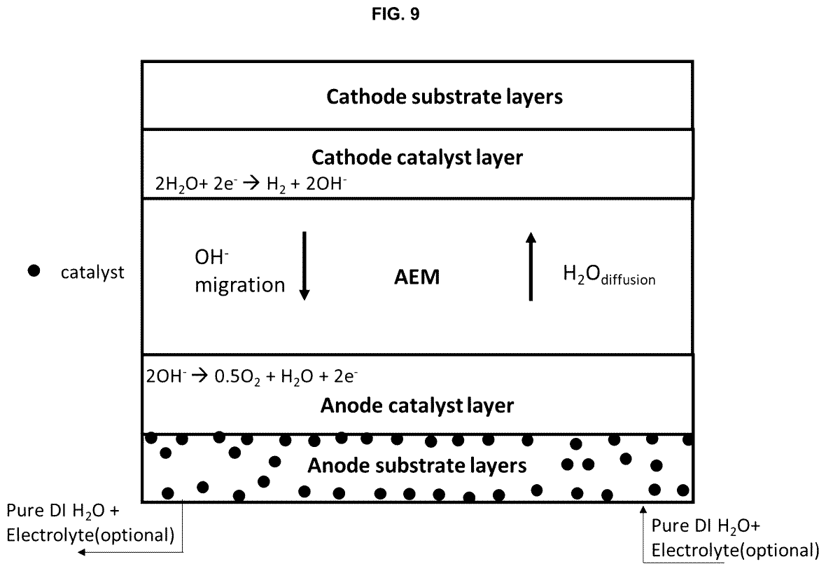

The present application also includes a method for providing a dispersed catalyst layer throughout the anode substrate layers (FIG. 9). In some embodiments, the layer may be introduced throughout the anode substrate layers by forming an ink (catalyst+binder) to coat in the anode substrate layers using techniques such as but not limited to slot-die coating, spray-coating, doctor blading, dip coating, etc. Then, the coated surface can be dried with or without methods such as heating, convection flow, or vacuum. The catalyst layer can also be deposited using other techniques such as chemical vapor deposition, atomic layer deposition, electrochemical deposition, thermochemical deposition etc.

Introducing the combustion/oxidation catalyst can be in any or all combinations of the cases mentioned above.

### Electrolyzer and Electrolytic Cells

In another aspect, the present application is also directed to an electrolytic cell and a cell stack containing a plurality of electrolytic cells. Thus, in one aspect the present application provides a water electrolyzer. In a preferred embodiment of the application, the water electrolyzer is an anion exchange membrane water electrolyzer (or an AEMEL) which uses a solid polymer anion exchange membrane and essentially pure water, thus requiring very low concentration of liquid electrolyte (e.g., <250 mM alkaline electrolytes like KOH or NaHCO₃). A preferred construction of such an AEMEL includes end plates, between which are arranged “n” electrochemical cells each with its own gas diffusion layer, membrane, and porous transport layer, while being separated from each other by a bipolar plate (sometimes known as middle plate). The number of cells, “n”, can be 1 (known as a single cell) or multiple (known as a stack).

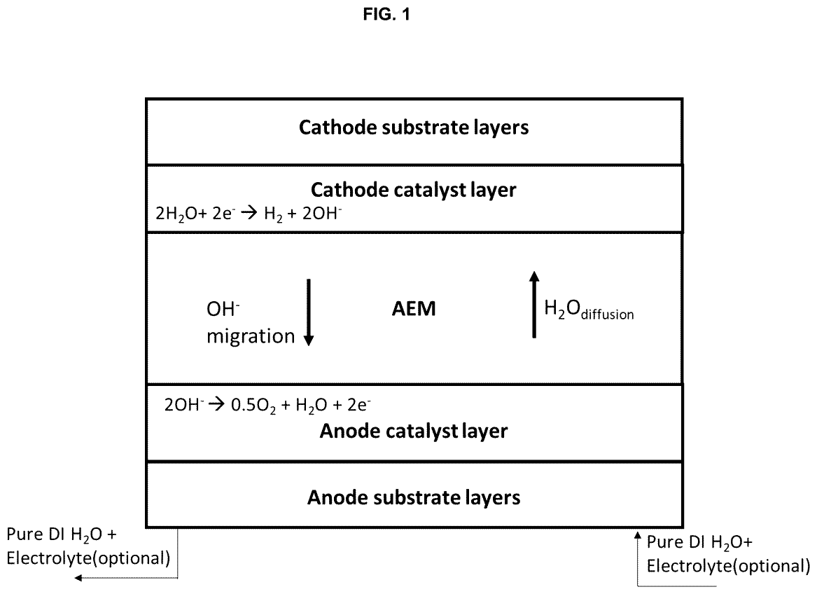

In embodiments of the present application, Anion exchange polymers are used as an AEM (Anion Exchange membrane) or as an AEI (Anion Exchange ionomers) for facilitating ion conduction in the electrolytic cell. The Anion Exchange polymer could be used as an AEI in both anode as well as cathode catalyst layers, as shown in FIG. 1. The AEI could also be used as a binder for any other ink formulations & coatings described above. For example, the AEI could be used as a binder for coating the combustion/oxidation catalyst onto the substrate. Then, another material that was discussed is the cross-linkers with functionalities such as ion conduction & facilitating catalytic reactions. These materials could be attached to the anion exchange polymer that is discussed here via cross-linking. This is applicable to anion exchange polymer used as membrane as well as an AEI. Another material that is discussed is a catalyst that can facilitate combustion of H₂ reaction with O₂ to minimize the leak of H₂ in O₂ compartment, or vice versa. This catalyst has a different purpose as compared to regular hydrogen & oxygen evolution catalyst used in the anode and cathode catalyst layers. This combustion/oxidation catalyst can be present in one or more of the following layers-membrane, anode catalyst layer, anode substrate layers. This catalyst can also be present in between any of the layers shown in FIG. 1.

### Preparation of Polymeric Materials, AEM, and AEI

Another aspect of the present application relates to approaches for preparing and/or making the polymer materials, AEM, AEI, electrolyzer components, catalysts, and electrolyzers discussed herein. It should be understood that the materials discussed above are incorporated in these methods, even if not explicitly stated below. For example, where the term cross-linker is used in discussing the preparation of the materials according to the present application, it should be understood the cross-linker may be a cross-linker discussed above, even if not recited again below (which is avoided to reduce repetition).

Thus, in another embodiment, the present application provides approaches and methods for making a random or a block of a multi-block copolymer from monomer units, making a multi-block copolymer from blocks, and cross-linking multi-block copolymers. Another aspect of the present application relates to methods of making an AEM using one or more monomers.

In some embodiments, methods for making the polymers of the present application include (but are not limited to) vinyl addition or ring-opening metathesis polymerization (ROMP) reaction. For example, the polymerization of substituted norbornene molecules in presence of a metal catalyst such as Pd and solvent leads to the formation of hydrophobic and/or hydrophilic polymer blocks of polymerized norbornene and/or alkene-based molecule, wherein the polymer has an all-hydrocarbon backbone. In some embodiments, the ratio of monomers to catalyst can range from about 1500:1 to about 1:1. Sequential and alternate addition of hydrophilic and/or hydrophobic monomers to the growing polymer yields a multi-block copolymer. The solvent could be non-polar such as toluene, xylene, chloroform, etc. The reaction mixtures can be left at ambient or elevated temperatures.

Another aspect of the present application relates to making multiblock copolymers via ring opening metathesis (ROMP) reaction. In some embodiments, the copolymer formed using this approach comprises a hydrophobic and/or hydrophilic block. The hydrophobic block may have a substituted, C₂ to C₂₀, branched or unbranched alkyl spacer chain. The hydrophilic block may have a substituted alkyl spacer chain with electrophilic carbon groups. Two or more hydrophilic blocks may be connected via a cross-linker which includes, but is not limited to, a multi heterocyclic or spirocyclic amine connected either through a C₂ to C₂₀ alkyl spacer chain or through a heterocyclic spacer chain connected through a heteroatom such as N. The hydrophilic groups can also be functionalized to produce a heterocyclic or spirocyclic amine functional group. In one embodiment of the present application, the copolymer can be used as an ionic adhesion layer between any layers for avoiding the delamination. In some embodiments, this adhesion layer may be referred to or understood as an “inter-layer.”

In some embodiments, the AEM of the present application is stabilized and/or reinforced with a stabilizing agent. Examples of the stabilizing agent include, but are not limited to, perfluorinated tetrafluoroethylene, ethylene tetrafluoroethylene, polybenzimidazole, styrene butadiene, or styrene ethylene butylene styrene or polyolefins. The stabilizing agent can take the form of woven or non-woven fabric, or individual fibers, or as a microporous inert substrate that can form interpenetrating network of polymers. The size of the strands could be in the range of molecular size to macro strands with dimensions of 0.01 to 1 mm, or larger. The amount of stabilizing agent can vary between 1 wt. % to 80 wt. %.

Some embodiments of the present application provide for the in-situ functionalization of polymer materials discussed herein. In some embodiments, the polymer can be dissolved in a solvent or a mixture of multiple solvents such as H₂O, isopropanol, n-propanol, ethanol, methanol, acetone, tetrahydrofuran, toluene, chloroform, etc. The polymer can also be dissolved in functionalizing organic amines which may be liquids such as trimethylamine, N-methyl piperidine, etc. In some embodiments, the functionalizing organic amines, such as N-methyl piperidine or trimethylamine, are cross-linkers. In some embodiments, functional additives are added either with solvent to the dry resin or without. The functional additives can modify the chemical structure of the polymer. In various aspects, the functional additives could be a cross-linker or a molecule that functionalizes the polymer groups.

In some embodiments, polymer modification (e.g. for enhanced activity or mechanics) is accomplished by adding dry ionomer powder to a solvent to produce an ionomer solution. Functional additives are then optionally added to the ionomer solution, rendering a modified polymer solution. Functionalization and/or crosslinking may be initiated via a polymerization reaction between two monomer units, via halide-containing terminal groups, or a similar reaction. If the polymer is used as an ink, an optional catalyst may be added to produce a catalyst containing ink, or no catalyst may be used to produce a catalyst-free ink.

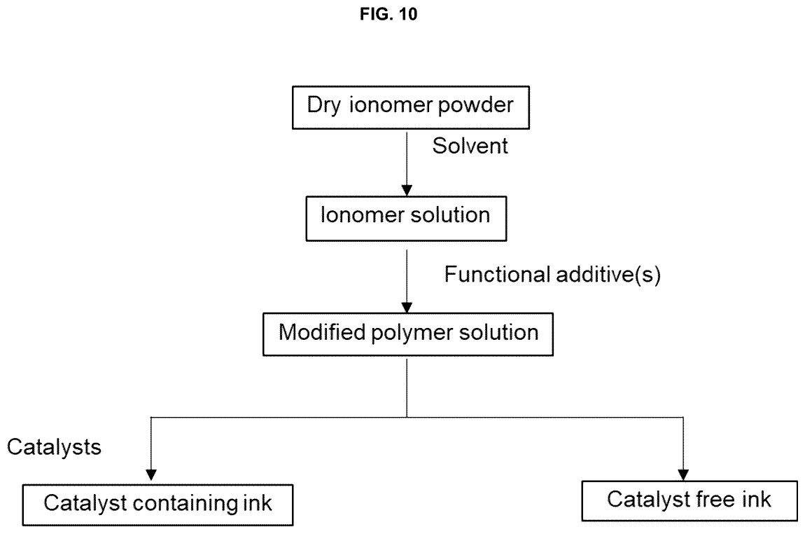

An overview of polymer modification for enhanced activity or mechanics is as depicted in FIG. 10. In particular dry ionomer powder may be dissolved in a solvent to produce an ionomer solution. Functional additives may be added to the ionomer solution to produce a modified polymer solution. Optionally, catalysts may be added to produce a catalyst containing ink. If no catalyst is added, a catalyst free ink may be produced.

In certain embodiments, prepared inks may optionally be homogenized using sonication and shear mixing and then coated onto a substrate, which in certain embodiments is a felt, foam, mesh, sintered plate, or sheet. In some embodiments, the felt is made of a stainless steel or Nickel, or an alloy thereof, or carbon fibers in the form of graphite, carbon black, coke, or other allotropes thereof. In some embodiments, a foam is made of a stainless steel or Nickel, or an alloy thereof. In some embodiments, a sheet is made of stainless steel or Nickel, or an alloy thereof, or may optionally be constructed of a polymeric membrane, which may or may not be a separate component from the AEM discussed herein. In some embodiments, a sheet is mechanically perforated or expanded to modify physical characteristics, such as but not limited to porosity, specific weight, and permeability to gases and liquids. In some embodiments, the mesh is made of a stainless steel or Nickel, or an alloy thereof. In some embodiments, the sintered plate is made of a stainless steel or Nickel, or an alloy thereof, and is constructed by sintering together powders, fibers, wires, and/or neat substrates discussed herein.

In some embodiments, the prepared ink is coated onto the substrate either through spray-coating, slot-die coating, doctor-blading, dip-coating, screen-printing, gravure drum, rod-coating, or chemical vapor deposition.

### Roll-to-Roll Manufacturing of Components:

Another aspect of the present application includes a method for manufacturing multiple layers of the components of the present application simultaneously at high speeds, e.g., between 1-25 m/min. As described above, the electrolytic cells have multiple components in several layers. The present application thus describes how to create these layers in two or more combinations simultaneously.

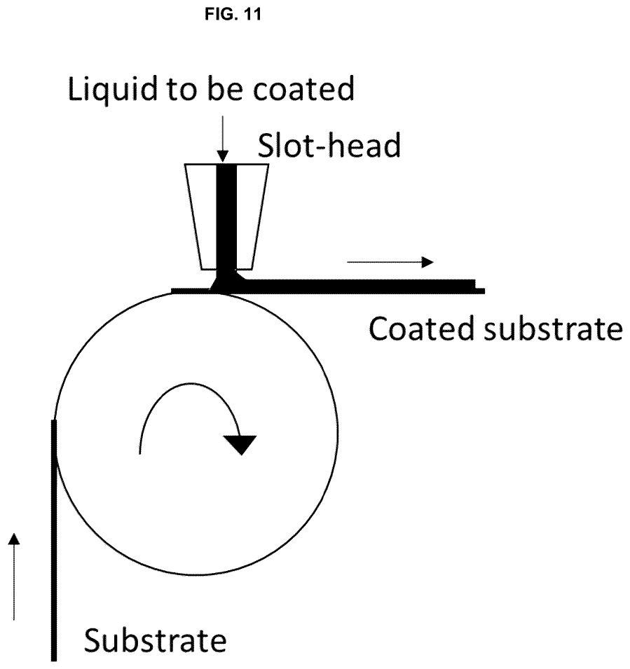

A schematic of a slot-die coating operation is depicted in FIG. 11. In this embodiment, a substrate passes around a roller and passes under a slot die, which distributes the coating fluid across a desired coating width before coating the substrate. The substrate moves relative to the slot die as the coating is coated onto the substrate. In some embodiments, the substrate is heated before, while, or after passing under the slot die in order to modulate the drying of the coating.

### Example: Multi-Layer Slot-Die Head

In one embodiment of the present application, multiple layers can be coated in a viscous liquid form using slot-die machines. As depicted in FIG. 11, traditionally, only single layer will get coated on to a substrate. The present application provides methods and devices for coating multiple layers simultaneously in liquid form.

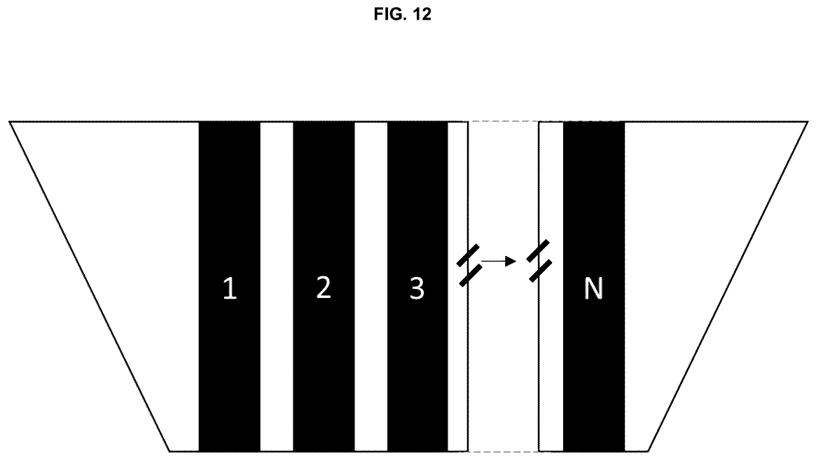

FIG. 12 depicts an embodiment of a multi-layer coat-able slot-die head. Here N layers of liquid may be simultaneously coated on a coating side of a substrate. In a preferred embodiment, N is between 2 to 15.

### Example: Multiple Slot-Die Heads Along the Coating Web

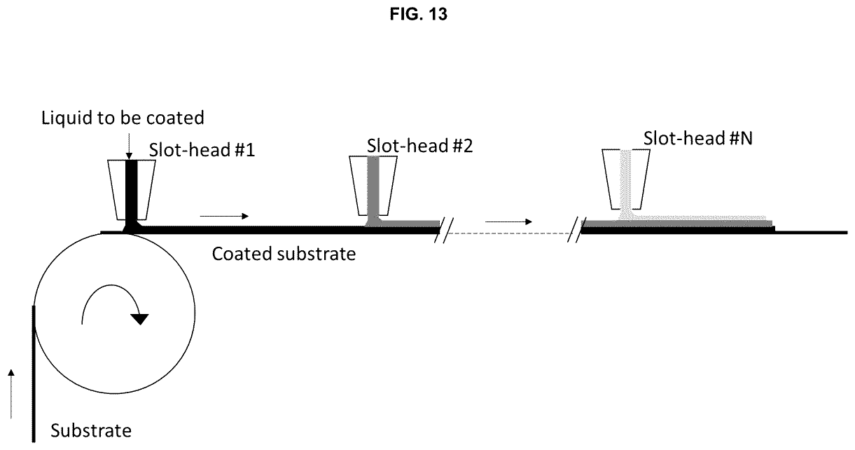

FIG. 13 depicts an embodiment in which a plurality of slot-die heads are used. The present application thus provides methods and devices for coating multiple layers using at least 2 coating slot-die heads along the coating line for multi-layered coating. In a preferred embodiment, the substrate may be coated using N slot die heads. In a preferred embodiment, N is 1 to 25.

In some embodiments each slot-die head may coat 2 or more layers. In some embodiments, slot-dies are placed one after another, i.e. combining the approaches depicted in FIGS. 12 and 13 (and discussed above). In some embodiments the slot-dies are placed with some other processing unit separating them such as dryer or more rollers etc. In some embodiments, the web consists of a combination of multiple types of coating tools such plasma treatment, dryer, gravure drum, spray-coater, heated rollers, etc.

In some embodiments, the coated substrate (coated with ionomer) may be further treated with a functional additive according to the present application, for example, the tertiary amines or heterocyclic amines discussed herein. In some embodiment, the coated ionomer containing a functional additive does not contain an added catalyst. In some embodiments, the coated substrate may be treated with an aqueous salt solution, for example, a solution containing KOH, NaOH, NaCl, KCl, KBr, NaBr, etc.

Cell assembly is normally done by sandwiching the membrane with the prepared electrodes. However, in one embodiment, a layer of anion-exchange polymer can be coated on a substrate (anode or cathode) with the purpose of casting the membrane directly on the substrate and not as a separate component. Once the polymer solidifies, it acts like a membrane separating one electrode from the other. This minimizes boundary resistance, increases polymer adhesion, reduces cell degradation due to washout, and more.

### Example: Cathode Catalyst Ink Formulation and Testing

A dry polymer powder was made using poly(norbornene) backbone. Two types of monomers—with a hydrophobic alkyl terminating side chain and a hydrophilic alkyl halide terminating side chain were used to synthesize a random co-polymer. After synthesis, 6.9 g dry powder of this polymer was used to make catalyst ink. This powder was placed in a pyrex glass jar. Then, solvents in the catalyst ink had a composition of Ethanol (99.5%): 194 ml, methanol: 56.4 ml, Deionized H₂O: 14.1 ml, trimethyl amine (46% aqueous solution). 39.24 g of Pt/C (47% wt Pt) was added to the solution. Then, the ink was sonicated and high shear mixed for uniformity. This was followed by coating the ink onto a gas diffusion substrate (GDS) made from carbon paper. The ink was coated onto the GDS roll at a speed of ˜1 cm/s. A total of ˜15 m of the roll was coated with the catalyst ink. After coating, the roll passed through the dryer section which then removed all residual solvent from the coated layer. After drying, the coated roll was winded for compact storage.

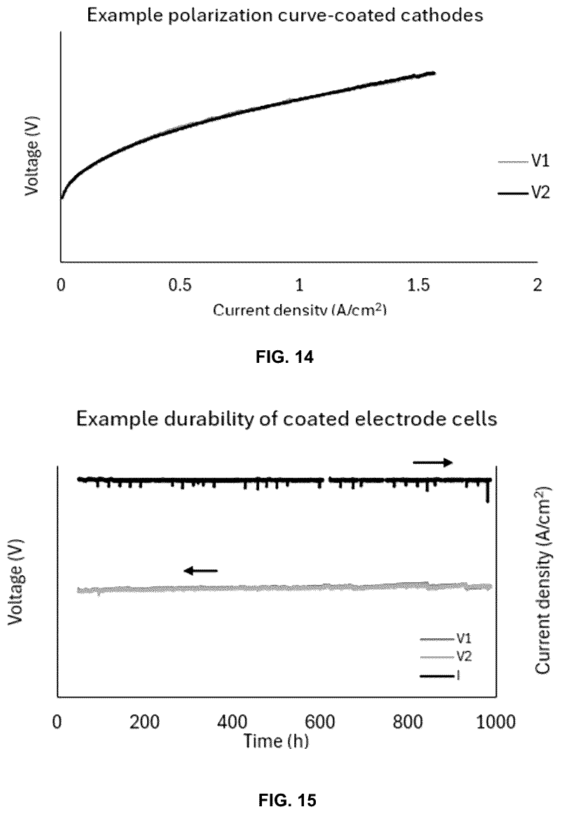

From the coated GDS, a small rectangular piece was cut to be evaluated for testing in the small electrolyzer test stack. The test stack contained a coated cathode with 0.5 mg Pt/cm². The membrane used was a similar polymer with poly(norbornene) backbone functionalized with N-methyl piperidine quaternary amine. The anode used is NiFe. A 10 mM K₂CO₃ was flown on the anode side as a supporting electrolyte. The supporting electrolyte was heated to reach a temperature of 60-70° C. using external heating prior to inlet. The stack power was turned on after the temperature attained equilibrium. The current density was increased from 0 to a constant value. The stack was held at this current overnight and a slow voltage-current polarization curve was taken at a step rate change of 0.1 A/15 s from 1.5 to 0 A/cm². The cell polarization curve is shown in FIG. 14. As shown in FIG. 14, the two replicates of identical coated electrodes perfectly match with each other, which demonstrates the repeatability and quality of ink formulation as well as coating.

After polarization curve, the stack was held at a constant current density for ˜1000 h. The data for durability is shown below in FIG. 15. As shown in the FIG. 15 we demonstrate that the stack has a very good durability by using the polymeric materials described in the present invention to fabricate Membrane-electrode assembly for higher performing, repeatable and longer lasting electrolyzer devices.

The foregoing description of preferred embodiments has been presented for purposes of illustration and description only. It is not intended to be exhaustive or to limit the application to the precise form disclosed, and modifications and variations are possible and/or would be apparent considering the above teachings or may be acquired from practice of the application. The embodiments were chosen and described to explain the principles of the application and its practical application to enable one skilled in the art to utilize the application in various embodiments and with various modifications as are suited to the particular use contemplated. It is intended that the scope of the application be defined by the claims appended hereto and that the claims encompass all embodiments of the application, including the disclosed embodiments and their equivalents.

1. An anion exchange polymer comprising a compound of Formula (I) 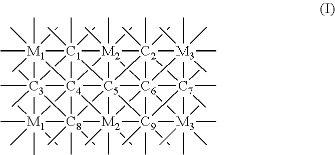
wherein:
each □ represents an optional chemical bond, which may be a single or double bond, an ionic bond (or electrovalent bond), a hydrogen bond, or a polar covalent bond;
each Mₙ (with n≥2) represents a monomer unit, wherein each Mₙ is optionally of different type or class (hydrophilic, hydrophobic); and
each Cₙ (with n≥1) represents a cross-linker, wherein each Cₙ is optionally of a different type or class.

2. The anion exchange polymer of claim 1,
wherein the anion exchange polymer is dissolved in a solvent and functionalized with a tertiary amine.

3. The anion exchange polymer of claim 1,
further comprising a metal-organic compound bonded to the anion exchange polymer via cross-linking having the following formula: 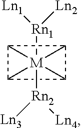
wherein:
each Rₙ₍ᵢ₎ is H or a carbon-containing moiety, with i≥1 (e.g. Rₙ₁, Rₙ₂, etc.);
M is an organometallic complex comprising a metal atom or metallic molecule in a coordination bond with an organic molecule or atoms, wherein the organic molecule optionally contains C, H, N, O, F, and/or S atoms and/or the organic atoms are C, H, N, O, F, and/or S, wherein the Metal of M is optionally Co, Fe, Ni, Pt, Ru, Ir, Mo, Ce, Mn, Cu, or Si;
each Lₙ₍ᵢ₎ is a ligand molecule that forms a coordination bond with the metal complex as well as connects to the polymer backbone; with i≥1 (e.g. Lₙ₁, Lₙ₂, etc.),
wherein the ligand molecule contains but is not limited to C, H, N, O, F, and S atoms,
wherein the ligand molecule can be connected to one or more monomer units which may be hydrophilic or hydrophobic,
wherein Rₙ₍ᵢ₎ may be omitted and one or more of Lₙ₍ᵢ₎ bonds directly with M.

4. An electrolytic cell comprising
a cathode substrate layer;
a cathode catalyst layer;
a membrane;
an anode catalyst layer; and
an anode substrate layer.

5. A method of incorporating a catalyst into a layer of an electrolytic cell selected from the group consisting of a cathode substrate layer, a cathode catalyst layer, a membrane, an anode catalyst layer, and an anode substrate layer, comprising
formulating an ink with or without an anion exchange ionomer (AEI) and
coating the layer using a technique selected from the group consisting of slot-die, gravure, spray-coating, atomic layer deposition, chemical vapor deposition.

6. The method of claim 5,
wherein the coating step employs a roll production of multiple layers simultaneously using a multi-layer coatable slot-die head.

7. The method of claim 5,
wherein the coating step employs a roll production of multiple layers simultaneously using multiple slot-die heads positioned along the coating web.

8. A method of facilitating oxidation, reduction, or combustion, comprising:
providing the anion exchange polymer according to claim 1.
